(19) United States
(12) Patent Application Publication
(10) Pub. No.: US 2003/0176288 A1
(43) Pub. Date: Sep. 18, 2003

(54) Halogen acid corrosion inhibitor base

(76) Inventor: Arthur Cizek, Houston, TX (US)

Correspondence Address: PAUL S MADAN, MADAN, MOSSMAN & SRIRAM, PC, 2603 AUGUSTA, SUITE 700, HOUSTON, TX, 77057-1130, US

(21) Appl. No.: 09/885,344

(22) Filed: Jun. 19, 2001

(51) Int. Cl. C09K 7/00

(52) U.S. Cl. 507/100

(57) ABSTRACT

The reaction product of thiourea (alternatively, a primary amine), formaldehyde, and an aromatic ketone (e.g. acetophenone) in the presence of an organic acid (e.g. acetic acid) and a mineral acid has been found effective as a corrosion inhibitor base for metals in acid media, particularly fluids containing halogen acids. The corrosion inhibitor base can be prepared in nearly 100% yield, and is a more effective base, as contrasted with bases prepared with fatty acids as contrasted with lower molecular weight organic acids such acetic acid.

### FIELD OF THE INVENTION

The invention relates to methods and compositions for inhibiting corrosion of metals, and, in one aspect, more particularly relates to methods and compositions for inhibiting corrosion of metals in acid environments where the acid contains halogen, such as hydrochloric acid, hydrofluoric acid, and the like.

### BACKGROUND OF THE INVENTION

It is well known that steel surfaces will corrode in the presence of acid environments. While the rate at which corrosion will occur depends on a number of factors, such as the steel alloy itself, the strength and type of acid, the temperature of the environment, the length of contact, etc., some sort of corrosion invariably occurs. Alloy technology has provided materials to withstand the incidental contact of steel with acid, but the corrosion problem is particularly aggravated when there is no choice but to contact steel with acid, as in the case of chemical processing where acids are employed. In instances where acid is not required to remain pure and where the contact is inevitable, attention has turned toward providing corrosion inhibitors in the acid medium itself to prevent corrosion of the steel surfaces that it must come into contact with, yet still deliver the acid to its ultimate destination. It would be advantageous if a new corrosion inhibitor base were discovered that would be an improvement over the presently known systems. For example, a corrosion inhibitor base providing a large corrosion inhibiting effect for a small proportion used would be advantageous.

Specific environments in which an improved corrosion inhibitor base would be appreciated include industrial cleaning and in the oil patch. With respect to oil and gas production, it is well known that during the production life of an oil or gas well, the production zone within the well may be chemically treated or otherwise stimulated to enhance the economical production lifetime of the well. A common way of doing this is by acid fracturing or matrix acidizing, whereby a highly acidic solution, generally having a pH of less than about 1, but which may be as high as about 6.9 is injected into the well. Spent acid in return fluids may have a pH of around 3-6.9, and organic acids used in acidizing include formic acid and acetic acid, each of which have a pH below 6.9. Because of the acidic nature of the treatment fluid, the production or workover conduit which is utilized in the well in such applications encounters considerable acidic corrosion, in the forms of surface pitting, embrittlement, loss of metal component and the like.

In earlier years of producing subterranean wells, the vast majority of production and workover conduits comprised carbon steels; they were utilized either temporarily or permanently in the well, and treatment and/or stimulation fluids were introduced through them into the well. Recently, due primarily to the drilling and completion of many subterranean wells through formations which contain high concentrations of corrosive fluids such as hydrogen sulfide, carbon dioxide, brine, and combinations of these constituents, the production and workover conduits for use in the wells have been made of high alloy steels. The high alloy steels include chrome steels, duplex steels, stainless steels, martensitic alloy steels, ferritic alloy steels, austenitic stainless steels, precipitation-hardened stainless steels, high nickel content steels, and the like.

Various corrosion inhibitor bases are known, to which are added other components, such as intensifiers, surfactants, oil wetting components, and the like.

U.S. Pat. No. 2,758,970 describes derivatives of rosin amines, which are represented by the formula:

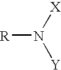

where R is a radical selected from the group consisting of abietyl, hydroabietyl, and dehydroabietyl, Y is the group CH₂R₁, X is a radical selected from the group consisting of hydrogen and CH₂R₁, and R₁ represents alpha ketonyl groups. These rosin amines are noted as useful in reducing the rate of corrosion of metals such as magnesium, aluminum and zinc when they are exposed to the action of a corrosive material such as hydrochloric acid.

Further, U.S. Pat. No. 3,077,454 describes compositions for inhibiting corrosion made by combining certain active hydrogen containing compounds with organic ketones having at least one hydrogen atom on the carbon atom alpha to the carbonyl group and an aldehyde selected from the group consisting of aliphatic aldehydes containing from 1 to 16 carbons, and aromatic aldehydes of the benzene series, having no functional groups other than aldehyde groups, and a fatty acid.

Additionally, Mannich base and thiourea inhibitor compositions and methods of inhibiting the acid attack by aqueous hydrofluoric acid on ferrous metal surfaces, and in particular highly reactive ferrous metal surfaces, are described in U.S. Pat. Nos. 3,992,313 and 4,104,303.

There remains a need for new, stable corrosion inhibitor bases and methods of use therefore which would work in halogen acid environments for a wide variety of metals, particularly iron alloys such as steels.

### SUMMARY OF THE INVENTION

Accordingly, it is an object of the present invention to provide compositions of matter effective in the inhibition of corrosion in halogen acid environments.

It is another object of the present invention to provide corrosion inhibitor base compositions for minimizing corrosion in halogen acid situations, which compositions may be easily made.

It is yet another object of the invention to provide methods and compositions for suppressing the corrosion of steels in halogen acid environments, which can be readily, implemented using conventional equipment.

Still another object of the invention is to provide a halogen acid corrosion inhibitor base, which is stable over time.

In carrying out these and other objects of the invention, there is provided, in one form, a halogen acid corrosion inhibitor base comprising a reaction product of thiourea, formaldehyde, and an aromatic ketone (e.g. acetophenone) in the presence of acetic acid and/or propionic acid, and a mineral acid. In one non-limiting embodiment of the invention, the halogen acid corrosion inhibitor base is prepared in the absence of a fatty acid, such as tall oil fatty acid.

### DETAILED DESCRIPTION OF THE INVENTION

It has been discovered that useful halogen acid corrosion inhibitor bases may be derived from thiourea (an amide) and represented by the formula:

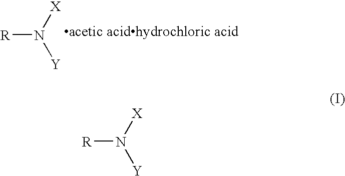

where in the formula:

R=a thiourea radical;

X=CH₂R¹

Y=H or CH₂R¹ and

R¹=an acetophenone radical.

Preferably the reaction is made in acetic acid and a mineral acid such as hydrochloric acid. Also preferably, a fatty acid, such as tall oil fatty acid, is absent. The resulting reaction product is a base, which may be used to formulate halogen acid corrosion inhibitors.

The materials of U.S. Pat. No. 3,077,454 can be made with approximately a 50% yield, and they require the presence of a fatty acid, such as a tall oil fatty acid. While U.S. Pat. No. 3,077,454 included the use of acetic acid in the preparations therein, they show that the resulting inhibitors prepared from this reaction product are less effective than when the reaction product includes the use of tall oil fatty acid. Surprisingly, it has been discovered herein that lower concentrations of lower molecular weight organic acids such as acetic acid used in the preparation yields high performing bases for corrosion inhibitor preparation.

While the inventive reaction product is similar in some respects to the U.S. Pat. No. 3,077,454 products, it was also surprisingly discovered that the invention provides a nearly 100% yield since all reactants and the reaction product are compatible. Further, it has also been surprisingly discovered that the reaction product is a more effective corrosion inhibitor base than the U.S. Pat. No. 3,077,454 reaction product in halogen acid corrosion inhibitors.

While a reaction product such as the type described in U.S. Pat. No. 3,077,454 may be made in about 100% yield by using paraformaldehyde instead of formaldehyde and adding a surfactant (an ethylene oxide adduct of nonylphenol) to couple the water soluble materials in the oil soluble reaction product, this approach was too costly.

As noted, the inventive reaction product is made in one embodiment by reacting thiourea with formaldehyde and a ketone in the presence of a low molecular weight carboxylic acid and a mineral acid.

It is expected that primary amines may also be employed as alternatives to thiourea to give useful inhibitor bases of this invention. Also, a primary amine such as rosin amine is preferred to the more water soluble amines such as ethylamine, propylamine and even butylamine.

Formaldehyde or any reactant that generates formaldehyde, such as paraformaldehyde would be suitable to make the corrosion inhibitor base of this invention. While a material such as tetramethylene pentamine would not be considered an equivalent to formaldehyde, it still might be used.

The aromatic ketone useful for this invention preferably contains at least one phenyl group such as acetophenone, which is preferred. The ketone may be represented by the formula:

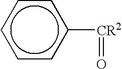

where R² is a straight or branched alkyl group of about 1 to about 6 carbon atoms. It is expected that most any aromatic ketone structure capable of condensing with formaldehyde can be useful.

Given the fact that it has been discovered that acetic acid gives better results, as described, than tall oil fatty acid, it is believed that the carboxylic acid forms part of the reaction product in some unknown way. It is expected that propionic acid may also work in addition to, or in place of the acetic acid. Formic acid was also examined, and while it performed, its solvency was unacceptable. The solvency of acetic acid may be preferred to tall oil fatty acid. Without being limited to any particular explanation or mechanism, the low molecular weight carboxylic acid may act as a coupler of inhibitor ingredients.

It is also preferred to make the reaction product in the presence of a mineral acid. Suitable acids include, but are not necessarily limited to, hydrochloric acid, nitric acid, phosphoric acid, hydrofluoric acid, and possibly mixtures thereof. Sulfuric acid should not be used. The mineral acid is believed to serve as a catalyst.

It will be appreciated that it is difficult to predict with accuracy which molar ratios give stable products. Nevertheless, to give some estimate, in one non-limiting embodiment, the broad molar ratios are 1 mole of thiourea (alternatively, a primary amine) to about 1.5 to about 5.0 moles aromatic ketone (e.g. acetophenone) to about 1.5 to about 10.5 moles of formaldehyde. In another non-limiting embodiment, preferred molar ratios are 1 mole of thiourea (or primary amine) to about 3.0 to about 3.5 moles aromatic ketone to about 7 to about 9 moles of formaldehyde. The proportion of non-fatty carboxylic acid (acetic or propionic) should be from about 10 to about 30 wt. % based on the total reactants, preferably from about 15 to about 25 wt. %. Again, it is preferred to keep the proportion of non-fatty carboxylic acid relatively low to give a better performing product.

Hydrochloric acid in 32 wt. % solution was used in the invention herein. The amount of mineral acid to be employed may range from about 2.5% to about 40% HCl in 32% concentration, based on the total amount of reactants. Preferably, the amount of acid is from about 5 to 15% HCl in 32% concentration.

The reaction to form the halogen acid corrosion inhibitor base may be conducted at a temperature between about 113° C. to about 127° C., preferably from about 115° C. to about 121° C. The reaction pressures should be from about atmospheric at the start to about 40-60 psi (280-410 kPa). Preferably, as the reaction proceeds the pressure increases from atmospheric to about 40 psi (280 kPa) and is released until it falls to about 20 psi (140 kPa) and kept in this range until the reaction is complete. As noted, yield to the reaction product is expected to be close to 100% with this system.

The halogen acid environments where the invention is useful encompass acid environments where the acid includes, but is not limited to, hydrochloric acid, hydrofluoric acid, formic acid, acetic acid, and mixtures thereof. Compound (I) has been found to have excellent stability, thus avoiding degradation over time. The corrosion inhibitors using this base will be cost effective and provide excellent corrosion control.

The acid corrosion inhibitor base may be combined with any suitable acidic injection medium, including but not necessarily limited to such media as downhole acidizing fluids and compositions; 15% and 28% concentrations of HCl, 15-5% acetic acid/HCl blend. Formic acid may also be used as an intensifier. It aids corrosion control at elevated temperatures and pressures with the inventive inhibitor.

Intensifiers are ingredients that extend inhibition of the inhibitor. Common intensifiers include, but are not necessarily limited to Cu₂l₂, Kl, formic acid, antimony and the like. Intensifiers are not corrosion inhibitors themselves. For instance, in non-limiting examples, formic acid functions as an intensifier in 15% and 28% concentrations of HCl, cuprous iodide also works as an intensifier in 15% and 28% concentrations of HCl, and antimony performs as an intensifier in 15% HCl.

Other ingredients may be used with the corrosion inhibitor base of this invention, and may include, but are not necessarily limited to, any acetylenic compound such as acetylenic alcohol; cinnamaldehyde, a nitrogen compound, such as a quaternary ammonium compound; and aromatic hydrocarbons or mixtures thereof, as is known to those skilled in the art. For example, teachings from acid corrosion inhibitors as made and described in U.S. Pat. Nos. 3,514,410; 3,404,094; 3,107,221; 2,993,863; and 3,382,179; may be utilized in accordance with the present invention. In one embodiment, the corrosion inhibitor contains at least one acetylenic alcohol having from 3 to 10 carbon atoms.

Examples of acetylenic compounds which may be used include propargyl alcohol (2-propyn-1-ol), hexynol, dimethyl hexynol, diethyl hexynediol, dimethyl hexynediol, ethyl octynol, dimethyl octynediol, methyl butynol, methyl pentynol, ethynyl cyclohexynol, 2-ethyl hexynol, phenyl butynol, and ditertiary acetylenic glycol.

Other acetylenic compounds which can be employed in accordance with the present invention include, but are not limited to, butynediol; 1-ethynylcyclohexanol; 3-methyl-1-nonyn-3-ol; 2-methyl-3-butyn-2-ol; also 1-propyn-3-ol; 1-butyn-3-ol; 1-pentyn-3-ol; 1-heptyn-3-ol; 1-octyn-3-ol; 1-nonyn-3-ol; 1-decyn-3-ol; 1-(2,4,6-trimethyl-3-cyclohexenyl)-3-propyne-1-ol; and in general acetylenic compounds having the general formula:

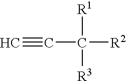

wherein R¹ is —H, —OH, or an alkyl radical; R is —H, or an alkyl, phenyl, substituted phenyl or hydroxyalkyl radical; and R³ is —H or an alkyl, phenyl, substituted phenyl or hydroxyalkyl radical.

The nitrogen or ammonia compounds can be optionally employed in accordance with the present invention, and they may include, but are not limited to, those amines having from 1 to twenty-four carbon atoms in each alkyl moiety as well as the six-membered heterocyclic amines, for example, alkyl pyridines, crude quino-lines and mixtures thereof. This includes such amines as ethylamine, diethylamine, triethylamine, propylamine, dipropylamine, tripropylamine, mono-, di- and tripentylamine, mono-, di- and trihexylamine and isomers of these such as isopropylamine, tertiary-butylamine, etc. This also includes alkyl pyridines having from one to five nuclear alkyl substituents per pyridine moiety, such alkyl substituents having from one to 12 carbon atoms, and preferably those having an average of six carbon atoms per pyridine moiety, such as a mixture of high boiling tertiary-nitrogen-heterocyclic compounds, such as HAP (high alkyl pyridines), Reilly 10-20 base and alkyl pyridines H3. Other nitrogen compounds include the crude quinolines having a variety of substituents.

The corrosion inhibitor may also contain a number of other constituents, such as fatty alcohol adducts, nonyl phenol adducts and tallow amine adducts, tall oil adducts, such as surfactants. Oil wetting components, such as heavy aromatic solvents, may also be present. In another non-limiting embodiment of the invention, the corrosion inhibitor contains at least one saturated alcohol having from 1 to 5 carbon atoms, and at least one alkyl phenol or alkoxylated alkyl phenol having from 15 to 24 carbon atoms.

A necessary component of the treatment fluid of the present invention is the base reaction product (I), previously described. The overall corrosion inhibitor formulation may contain from about 10 to about 50 wt. % base reaction product (I), preferably from about 15 to about 40 wt. %, and most preferably from about 15 wt. % to about 30 wt. %.

It will be appreciated that the halogen acid corrosion inhibitor of this invention may be used with conventional corrosion inhibitors as described below, and in any application where a steel surface, such as stainless steel, high alloy or other steel, is exposed to an acid environment. While the specific implementation of this invention is described in the context of the oil patch, the invention may certainly find uses in other applications where it is desirable to reduce corrosion, such as chemical processes that necessarily require the contact of acids with conduits, fittings, and other equipment, such as industrial cleaning applications.

In the implementation of the invention in the production of fluids from subterranean reservoirs, a fluid is introduced through a high alloy steel member or conduit positioned within the well. The fluid is an acidic injection medium and includes an acid corrosion inhibitor. The invention also encompasses a method of treating a well for enhancement of production within a production zone by introduction into the steel conduit of the acid corrosion inhibitor composition of this invention.

The fluid which is contemplated for use in one aspect of the present invention for treatment of a subterranean well for enhancement of production will be aqueous based; that is, it will be formed using sea water available at the well location, a brine, tap water or similar fluid. The amount of fluid used for the treatment will vary, of course, from well to well, and will be based upon the particular application at hand, and the amount thereof is not particularly critical to the method of the present invention. It will be appreciated that one of ordinary skill in the art of corrosion inhibition will be able to adapt the teachings of this invention to applications outside the realm of oil and gas recovery, such as the area of chemical processing, with only routine experimentation.

The expected treatment fluid in an oil production environment is expected to have as a primary additive an acidic injection medium, which may be any compatible acid, including but not limited to hydrochloric acid, hydrofluoric acid, formic acid, acetic acid, and mixtures thereof. The fluid with the acid injection medium therein should have a pH of no greater than about 6.9. Acidizing fluids can have pH of less than 1 when mixed with produced fluids which may have a pH as high as 6.9.

The treatment fluid also contemplates incorporation of other acid corrosion inhibitors, which typically will be provided in treatment concentrations of from about 1,000 ppm, based upon the weight of the entire treatment fluid to about 60,000 ppm of such weight. Most often, the total amount of corrosion inhibitors will range from about 1,000 to 20,000 ppm including any intensifier, if present. Formic acid is an intensifier and can be used at concentrations up to 100,000 ppm or more. Again, the treatment level of the acid corrosion inhibitor will vary depending upon the particular physical characteristics of the well, the high alloy steel conduit, temperature and pressure considerations, the selected acidic injection medium, and the like. In one non-limiting embodiment of the invention 30 gpt (30 lpt, liters per thousand) formic acid intensifier and 5-10 gpt (5-10 lpt) corrosion inhibitor in 15% HCl at 300° F. (149° C.) for 16 hours at 5000 psi (3.4×10⁴ kPa), and 70 gpt (70 lpt) formic acid and 5-10 gpt (5-10 lpt) in 28% HCl at 300° F. (149° C.) for 16 hours at 5000 psi (3.4×10⁴ kPa).

It will be appreciated that the treatment level of the acid corrosion inhibitor of this invention will vary depending upon a wide variety of parameters including, but not limited to, the particular physical characteristics of the system or well, the nature of the steel, temperature and pressure considerations, the acid and strength thereof in the system, and the like. Nevertheless, to give a sense of the typical proportions that might be used, non-limiting effective amounts of reaction product in the corrosion inhibitor ranges from about 0.1 to about 10 gpt (gallons of inhibitor per thousand gallons of acid), depending on the acid strength. (This could also be expressed as 0.1 to 10 lpt—liters per thousand liters of acid.) The treatment level also depends upon the temperature and exposure time, with the following being non-limiting, representative examples:

1-3 gpt (1-3 lpt) at ambient to 200° F. (93° C.) in 15% HCl and 6 hours exposure;

1-5 gpt (1-5 lpt) at ambient to 200° F. (93° C.) in 28% HCl and 6 hours exposure;

3-10 gpt (3-10 lpt) at 200 to 250° (93 to 121° C.) in 15% HCl and 6 hours exposure; and

5-15 gpt (5-15 lpt) at 200 to 250° (93 to 121° C.) in 28% HCl and 6 hours exposure.

Twenty (20) gpt (20 lpt) of corrosion inhibitor intermediate plus intensifiers is commonly used in acid systems at or above 250° F. (121° C.) in one non-limiting embodiment. Proportions of 2-4 gpt (2-4 lpt) may be suitable in some environments (N-80 steel test coupons) at up to 270° F. (132° C.).

The invention will be described further in the following illustrative Examples, which are non-limiting and serve only to further illuminate the invention.

### EXAMPLE 1

### Halogen Acid Corrosion Inhibitor Base Preparation

To a stirred PYREX pressure cell was placed 82.7 g acetophenone, 16.5 g thiourea, 45.8 g paraformaldehyde, 40 g 20% acetic acid, and 15 g 32% HCl. This is a 3/1/6.25 mole ratio of acetophenonelthiourea/paraformaldehyde. The mixture was stirred and heated to 245-250° F. (118-121° C.) and held at this temperature for 4.5 hours. The pressure was maintained at or below 45 psi (310 kPa) by periodically releasing pressure. After 4.5 hours at temperature, the reaction was cooled. The product was given the designation A-Nₒ.

### EXAMPLE 2

A product of this invention can also be made by reacting together the following weight proportions of components using the procedure of Example 1:

| | |
|---|---|
| Thiourea | 7.69 |
| Acetophenone | 38.43 |
| Paraformaldehyde | 23.88 |
| Acetic acid | 20.00 |
| 32% HCl | 10.00 |
| | 100.00 |

### EXAMPLE 3

The A-Nₒ base of Example 1 was used to prepare the corrosion inhibited formulations A-I shown in Table I.

TABLE I
Preparation of Corrosion Inhibitors Using Example 1 Base

| Ingredients | A | B | C | D | E | F | G | H | I |
|---|---|---|---|---|---|---|---|---|---|
| A-Nₒ | 30 | 30 | + | 20 | 20 | 20 | 25 | 25 | 25 |
| Propargyl alcohol | 10 | 10 | 10 | 10 | 10 | 10 | 10 | 10 | 10 |
| Heavy aromatic | 10 | 15 | 20 | 10 | 15 | 20 | 10 | 15 | 20 |
| solvent | | | | | | | | | |
| Nonylphenol + 20 | 15 | 15 | 15 | 15 | 15 | 15 | 15 | 15 | 15 |
| moles ethylene oxide | | | | | | | | | |
| Isopropyl alcohol | 15 | 15 | 10 | 20 | 20 | 15 | 20 | 15 | 15 |
| Methyl alcohol | 20 | 15 | 15 | 25 | 20 | 10 | 20 | 20 | 15 |

### EXAMPLE 4

### Evaluation as Corrosion Inhibitors

Corrosion inhibiting formulations A-I of Example 3 were evaluated as corrosion inhibitors in 15% HCl for 6 hours at 250° F. (121° C.) and 2000 psi (1.4×10⁴ kPa) using N-80 oil field pipe coupons using 6 and 8 gpt (6 and 8 lpt) of inhibitor. The results are presented in Table II where they are compared favorably with commercially available CRONOX 242ES corrosion inhibitor available from Baker Petrolite.

TABLE II
Lbs/ft² (kg/m²) N-80 Steel Corrosion Rate at
250° F. (121° C.), 2000 psi (1.4 × 10⁴ kPa)

| Corrosion | | | | |
|---|---|---|---|---|
| inhibitor | | | | |
| formulation | 6 gpt (6 lpt) | Formulation | 8 gpt (8 lpt) | Formulation |
| A | 0.310 | (1.51) | 0.112 | (0.596) |
| B | 0.118 | (0.576) | 0.053 | (0.259) |
| C | 0.062 | (0.303) | 0.048 | (0.234) |
| D | 0.270 | (1.32) | 0.148 | (0.723) |
| E | 0.257 | (1.25) | 0.120 | (0.586) |
| F | 0.113 | (0.552) | 0.087 | (0.425) |
| G | 0.304 | (1.48) | 0.197 | (0.962) |
| H | 0.250 | (1.22) | 0.165 | (0.806) |
| I | 0.110 | (0.537) | 0.200 | (0.976) |
| CRONOX | 0.069 | (0.337) | 0.053 | (0.259) |
| 242ES | | | | |

Many modifications may be made in the present invention without departing from the spirit and scope thereof that are defined only by the appended claims. For example, certain components per se, or combinations of components thereof other than those specifically set out herein may be found by one of routine skill in the art to be particularly advantageous. Additionally, certain proportions of reactants may produce reaction products or proportions of reaction products having particular efficacy.

I claim:

1. A halogen acid corrosion inhibitor base comprising a reaction product of thiourea, formaldehyde, and an aromatic ketone made in the presence of a mineral acid and an acid selected from the group consisting of acetic acid, propionic acid, and mixtures thereof.

2. The halogen acid corrosion inhibitor base of claim 1 where the aromatic ketone has the formula: 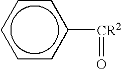
where R² is a straight or branched alkyl group of about 1 to about 6 carbon atoms.

3. The halogen acid corrosion inhibitor base of claim 2 where the aromatic ketone is acetophenone.

4. A halogen acid corrosion inhibitor base comprising a reaction product of thiourea, formaldehyde, and acetophenone made in the presence of acetic acid and a mineral acid.

5. The halogen acid corrosion inhibitor base of claim 1 further comprising a compound of the structure: 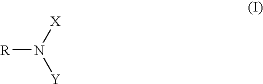
where R=a thiourea radical;
X=CH₂R¹
Y=H or CH₂R¹ and
R¹=an acetophenone radical.

6. A halogen acid corrosion inhibitor comprising a corrosion inhibitor base including a reaction product of thiourea, formaldehyde, and an aromatic ketone made in the presence of a mineral acid and an acid selected from the group consisting of acetic acid, propionic acid, and mixtures thereof.

7. The halogen acid corrosion inhibitor of claim 6 where in the corrosion inhibitor base the aromatic ketone is acetophenone.

8. A halogen acid corrosion inhibitor comprising a corrosion inhibitor base including a reaction product of thiourea, formaldehyde, and acetophenone made in the presence of acetic acid and a mineral acid.

9. The halogen acid corrosion inhibitor of claim 8 further comprising:
at least one acetylenic alcohol having from 3 to 10 carbon atoms;
at least one saturated alcohol having from 1 to 5 carbon atoms; and
at least one alkylphenol or alkoxylated alkyl phenol having from 15 to 24 carbon atoms.

10. The halogen acid corrosion inhibitor of claim 8 where the amount of corrosion inhibitor base in the corrosion inhibitor ranges from about 10% to about 50 wt. % based upon the total corrosion inhibitor.

11. The halogen acid corrosion inhibitor of claim 8 where the corrosion inhibitor base further comprises a compound of the structure: 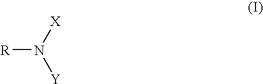
where R=a thiourea radical;
X=CH₂R¹
Y=H or CH₂R¹ and
R¹=an acetophenone radical.

12. A method of inhibiting the corrosion of metals in the presence of a liquid medium containing at least one halogen acid comprising including in the fluid a corrosion inhibitor comprising a corrosion inhibitor base including a reaction product of thiourea, formaldehyde, and an aromatic ketone made in the presence of a mineral acid and an organic acid selected from the group consisting of acetic acid, propionic acid and mixtures thereof.

13. The method of claim 12 where in the corrosion inhibitor base, the aromatic ketone is acetophenone.

14. A method of inhibiting the corrosion of metals in the presence of a liquid medium containing at least one halogen acid comprising including in the fluid a corrosion inhibitor comprising a corrosion inhibitor base including a reaction product of thiourea, formaldehyde, and acetophenone made in the presence of acetic acid and a mineral acid.

15. The method of claim 14 where the halogen acid corrosion inhibitor further comprises:
at least one acetylenic alcohol having from 3 to 10 carbon atoms;
at least one saturated alcohol having from 1 to 5 carbon atoms; and
at least one alkoxylated alkyl phenol having from 15 to 24 carbon atoms.

16. The method of claim 14 where in the halogen acid corrosion inhibitor the amount of corrosion inhibitor base in the corrosion inhibitor ranges from about 10% to about 50 wt. % based upon the total corrosion inhibitor.

17. The method of claim 14 where the corrosion inhibitor base further comprises a compound of the structure: 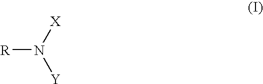
where R=a thiourea radical;
X=CH₂R¹
Y=H or CH₂R¹ and
R¹=an acetophenone radical.

18. The method of claim 14 where the halogen acid in the liquid medium is selected from the group consisting of hydrochloric acid, hydrofluoric acid, and mixtures thereof.

19. The method of claim 14 where the metals are iron alloys.

20. A fluid for contacting a metal surface, the fluid comprising
at least one halogen acid; and
a corrosion inhibitor comprising a corrosion inhibitor base comprising an effective amount of a reaction product of thiourea, formaldehyde, and an aromatic ketone made in the presence of a mineral acid and an organic acid selected from the group consisting of acetic acid, propionic acid, and mixtures thereof.

21. The fluid of claim 20 where in the reaction product the aromatic ketone is acetophenone.

22. A fluid for contacting a metal surface, the fluid comprising
at least one halogen acid; and
a corrosion inhibitor comprising a corrosion inhibitor base comprising an effective amount of a reaction product of thiourea, formaldehyde, and acetophenone made in the presence of acetic acid and a mineral acid.

23. The fluid of claim 22 where the halogen acid corrosion inhibitor further comprises:
at least one acetylenic alcohol having from 3 to 10 carbon atoms;
at least one saturated alcohol having from 1 to 5 carbon atoms; and
at least one alkoxylated alkyl phenol having from 15 to 24 carbon atoms.

24. The halogen acid corrosion inhibitor of claim 22 where the amount of corrosion inhibitor base in the corrosion inhibitor ranges from about 10% to about 50 wt. % based upon the total corrosion inhibitor.

25. The halogen acid corrosion inhibitor of claim 22 where the corrosion inhibitor base further comprises a compound of the structure: 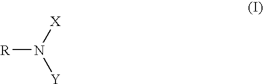
where R=a thiourea radical;
X=CH₂R¹
Y=H or CH₂R¹ and
R¹=an acetophenone radical.

26. The fluid of claim 22 where the effective amount of the reaction product ranges from about 0.1 to about 10 gpt (0.1 to 10 lpt) based on the amount of halogen acid.
